(19) United States
(12) Patent Application Publication
(10) Pub. No.: US 2020/0107503 A1
(43) Pub. Date: Apr. 9, 2020

(54) SELF-SHARPENING KNIFE

(71) Applicant: Vincent BERNARD, St. Ephrem (CA)

(72) Inventor: Vincent BERNARD, St. Ephrem (CA)

(21) Appl. No.: 16/152,397

(22) Filed: Oct. 4, 2018

(51) Int. Cl. A01F 29/22; B01F 7/00

(52) U.S. Cl. CPC A01F 29/22; B01F 2215/0008; B01F 7/003

(57) ABSTRACT

A self-sharpening knife used inside an agricultural machine to cut and mix balls of hay or other food destined for animals consumption. The knife comprises a generally triangular steel plate whose base is right or rounded. The base is provided with a series of teeth, each of the teeth includes a pastille made of a material harder than steel and self-sharpening. The pastilles end by a cutting edge having a contour which forms the cutting edge of a tooth.

The width of a pastille exceeds that of the steel and ends in a point which becomes round over cuts because of wear. The pastilles wearing out less quickly than steel thus causing that over cuts the width of the pastilles will always exceed the width of the steel. The pastilles cut until all their length and width are worn. The material of the pastille can be carbide or diamond.

### FIELD OF THE INVENTION

The present invention belongs to the field of the knives used to cut or mix balls of hay or other food, destined for animals consumption, inside an agricultural mixer. It is also used with other agricultural machines such as in the presses with balls of hay.

### PRIOR ART

A patent of the Prior Art drew our attention:

U.S. Pat. No. 5,823,449 “Agricultural feed mixer blade” filed on Jul. 21, 1997 and issued on Oct. 20, 1998 is a knife made up of a plurality of teeth on the front side of which are disposed cutting elements. These cutting elements are of generally triangular form and made of a material more resistant than the rest of the knife, such as cemented carbide.

These cutting elements increase the force of impact and the wear resistance of the knife.

### OBJECTIVES AND ADVANTAGES

The present invention provides a self-sharpening knife for agricultural mixer or other agricultural machines used to cut and mix balls of hay or other food used for animal consumption. The knife is provided with carbide pastilles or another material cutting and self-sharpening over the cuts and which is harder than steel. The pastilles make the lifetime of the knives longer than those existing on the market and allow them to have a greater wear resistance. And thus the knife will never need to be sharpened. The present invention will be further understood from the following description with reference to the drawings wherein like numbers refer to like parts for easy identification.

### BRIEF DESCRIPTION OF DRAWINGS FIGURES

FIG. 1 is a perspective view of a straight knife.

FIG. 2 is an enlarged view of the teeth with the pastilles disposed with angle on the top.

FIGS. 3A, 3B, 3C are enlarged views showing the shape of the tooth over wearing.

FIG. 4 is an enlarged view of a tooth with a pastille disposed in sandwich.

FIG. 5 is an enlarged view of a tooth with a pastille disposed horizontally on the tooth.

FIG. 6 is a perspective view of a convex knife.

FIG. 7 is a perspective view of a concave knife.

FIG. 8 is a perspective view of a knife having the form of a half-circle.

FIG. 9 is a perspective view of a series of teeth having the shape of pointed triangle with rectangular pastilles.

FIG. 9.1 is an enlarged view of a tooth of FIG. 9.

FIG. 10 is a perspective view of a knife having a series of teeth of a shape of pointed triangle with triangular pastilles.

FIG. 10.1 is an enlarging view of a tooth of the FIG. 10.

### DETAILED DESCRIPTION OF THE PREFERRED EMBODIMENT

In the following description and in the accompanying drawings, the numeral numbers refer to identical parts in the various Figures.

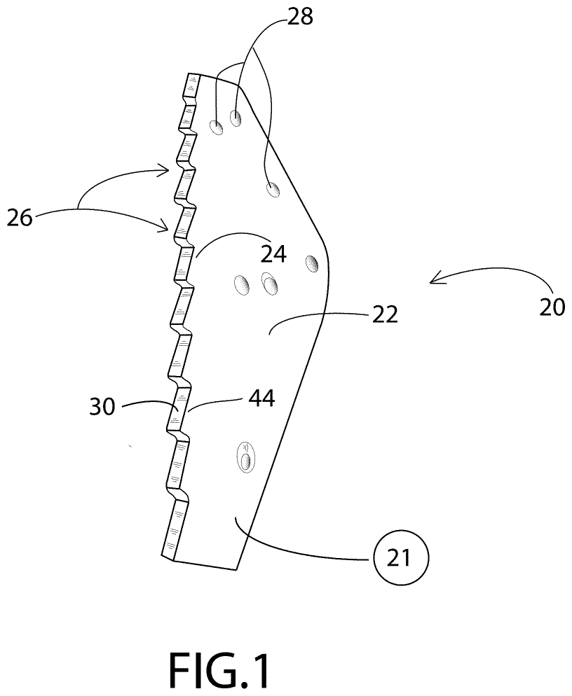

FIG. 1 shows the self-sharpening knife 20 of a generally triangular form, made of steel 22, and comprising a straight base 24 equipped at its end with a series of teeth 26.

Each tooth comprises on the top an encavure 44 in which is fixed a pastille 30 of a material harder than steel.

This pastille is cutting and self-sharpening over the cuttings.

The knife comprises holes 28 being used for installation in the mixer or in another agricultural machine.

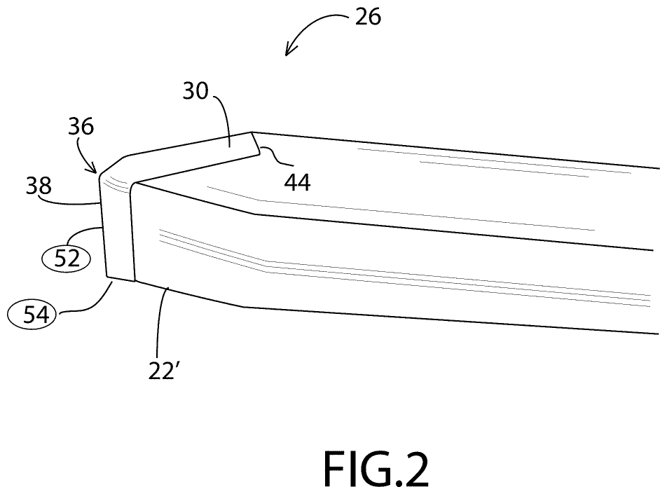

FIG. 2 shows an enlarged view of the teeth 26, one sees pastilles 30 placed inside encavures 44 and disposed with an angle.

The pastilles exceed the steel 22′ composing the rest of the tooth.

Each pastille ends in a cutting 52 having a contour 54, the cutting ends in a point 36 having an end 38. This pastille directed towards the bottom protects the steel component from wear.

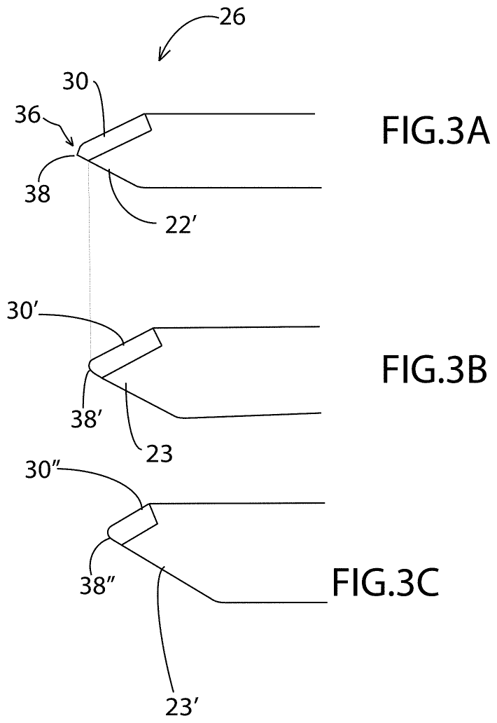

FIGS. 3A, 3B, 3C show the shapes the tooth 26 takes after some cuts. FIG. 3A shows the tooth at the beginning of the use with a new pastille 30 made of a material cutting and self-sharpening over the cuttings. The material is harder than steel and ends in a point 36 which comprises an end 38. The pastille exceeds the steel component 22′.

FIG. 3B shows the tooth with the pastille 30′ in which the point is round 38′ due to wear. The end 38′ of the pastille exceeds the end of the steel component because the pastille is harder than steel; it thus wears less quickly.

FIG. 3C shows the pastille decreased by one third 30″. The steel 23′ component decreases also simultaneously but more quickly than the pastille. The pastille always exceeds the steel component and cuts 38″ until it is worn over all its length and all its width.

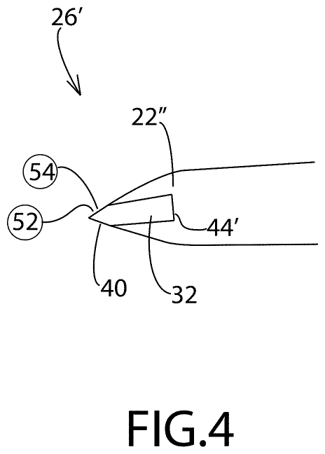

FIG. 4 shows a tooth 26′ having a pastille 32 disposed in sandwich in an encavure 44′ made in the steel 22″ component of the tooth 26′.

The pastille ends in a cutting 52 having a contour 54, the end of the cutting is a point 40. The tooth is at the beginning of its use because the end of the point is not yet round.

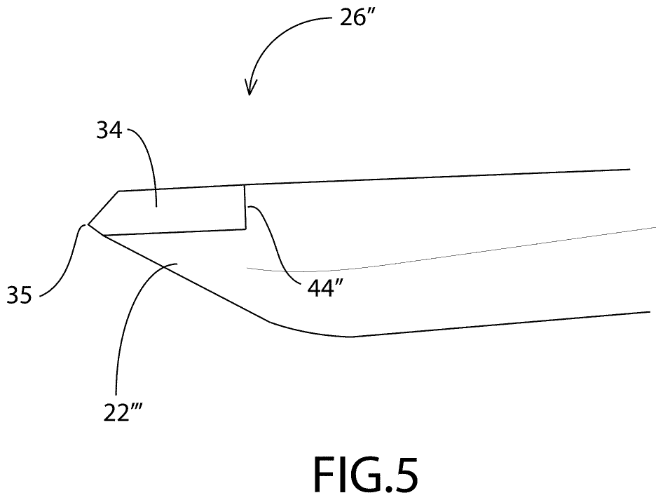

FIG. 5 shows a tooth 26″ having a pastille 34 disposed straight on the top of the tooth. It is placed in an encavure 44″ made in the steel 22′″ component of the tooth. The pastille is disposed parallel to the steel and it finishes in a cutting 52 having a point with an end 35.

The height of the pastille goes until the top of the tooth, the top of the pastille coincides with the top of the tooth.

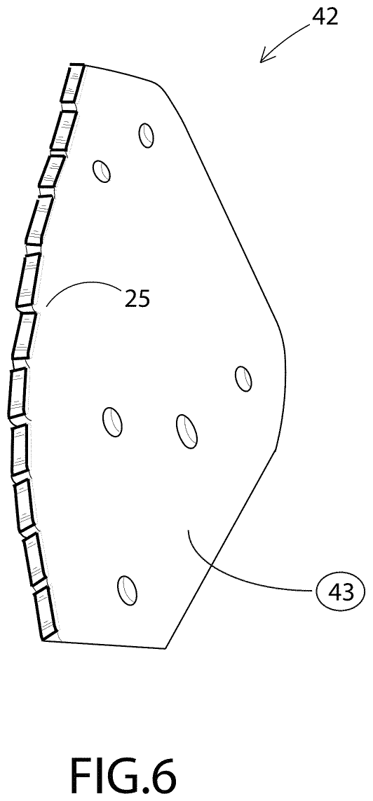

FIG. 6 shows a convex self-sharpening knife 42 with a steel 43 plate and having a convex base 25.

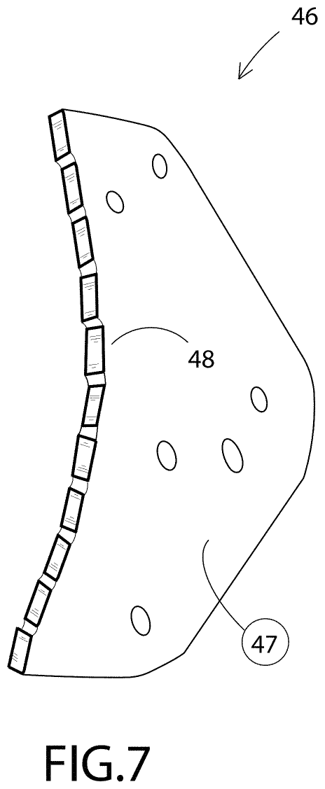

FIG. 7 shows a concave self-sharpening knife 46 including a steel plate 47 and having a concave base 48.

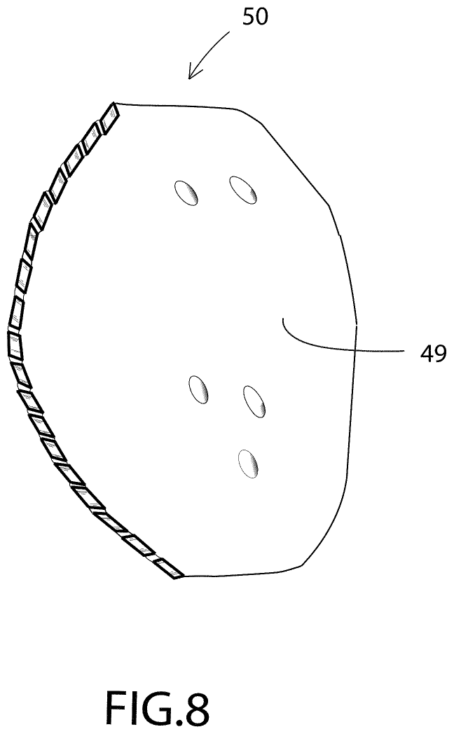

FIG. 8 shows a self-sharpening knife having the form of a half circle 50, it comprises a steel plate 49.

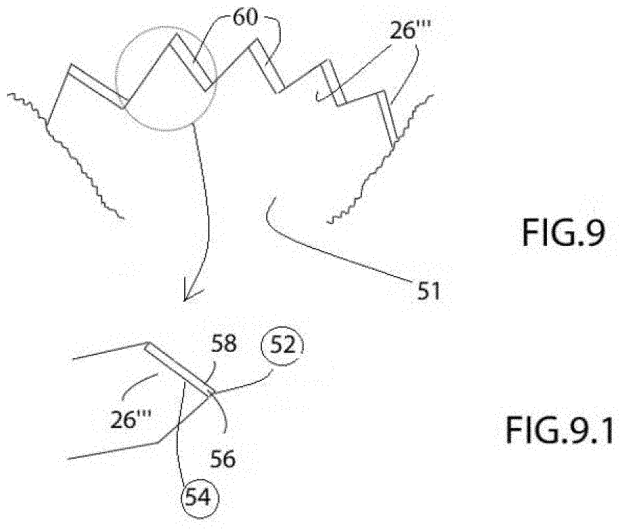

FIG. 9 shows a series of teeth having the shape of a sharp triangle 26′″. Each tooth 26′″ comprises a rectangular pastille 58. The pastille is fixed on the side face 60 uniting top 56 of the triangle, and the same face for each tooth. This form makes it possible to have more sharp teeth.

FIG. 9.1 is an enlarged view of a tooth of FIG. 9 which shows that each tooth comprises a rectangular pastille 58 fixed at angle. The pastille finishes in a cutting 52 having a contour 54.

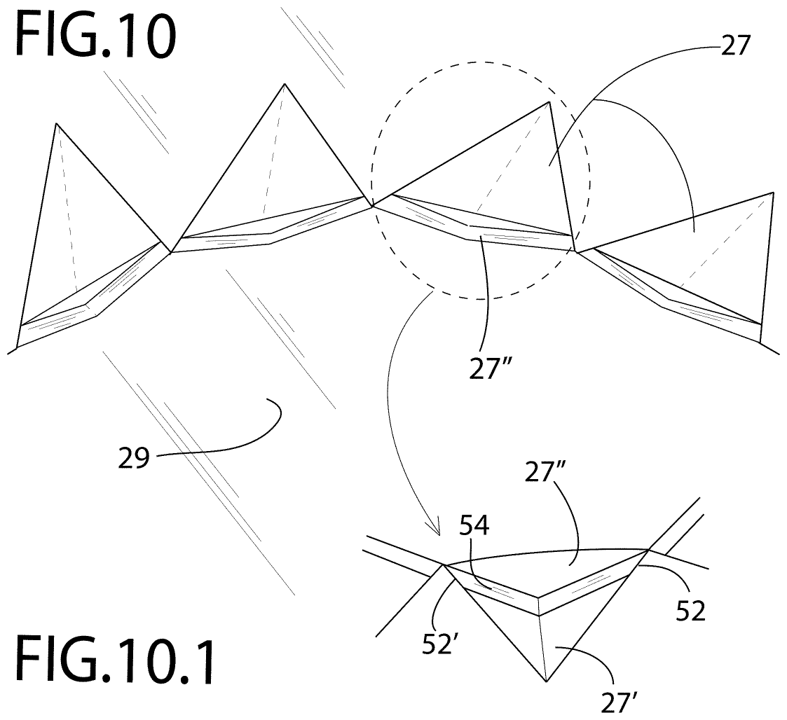

FIG. 10 shows teeth having the shape of a sharp triangle 27 having triangular pastilles 27″. These teeth are posed on a plate 29 of the self-sharpening knife made of steel.

FIG. 10.1 is an enlarged view of a tooth of FIG. 10 which shows that each tooth consists of two materials; the bottom part 27′ of the triangle is made on steel and the part in the top 27″ is a pastille of a triangular contour 54 made on a material harder than steel, the cuttings 52,52′ are on the two side faces.

### SUMMARY

A self-sharpening knife 20,42,46,50 comprising a steel plate 21,29,43, 47,49,51 of a geometrical form, the plate comprises aligned along an end a series of teeth 26,26′,26″,26′″,27 intended to cut, each one of the teeth comprises a thin pastille 27″,30,32,34,58 of a material more cutting and harder than steel. The pastille is fixed at the steel part of the tooth. The pastille exceeds the steel part and ends in a cutting 52,52′ having a contour 54, the contour forming the cutting edge of the tooth.

Over the cuttings the cutting edge becomes minimally round by keeping a thin diameter, the maximum diameter of the round corresponds to the thickness of the thin pastille; this minimal round allows the cutting edge to remain cutting.

The steel of the tooth wears simultaneously and more quickly because it is less harder than the pastille, so the pastille will always exceed the steel part and will cut until it is worn overall its length and all its width, the knife comprises also means of fastener used to fix it at an agricultural machine. The pastille could be fixed in an encavure made in the steel which has the same form as the pastille. The fixing could be silver brazing, or adhesive.

Thickness of the Steel Plate

The steel plate could have a thickness ranging between 3/16 and ½ po. The steel plate could also have a thin thickness allowing the self-sharpening knife to have a better cutting while resisting the impacts caused at the time of the cutting, the impacts happen with fragments who can get into the agricultural machine and damage the cutting.

Thickness of the Pastille

The thin pastille could have a thickness ranging between 1/32 and ⅛ po. The thin pastille could also have a thickness of 1/16 po, and during wear the maximum diameter of the round of the cutting edge is also 1/16 po and it does not increase any more due to wear, thus allowing the self-sharpening knife during the use to have a constant cutting, the pastille will not break due to the impacts caused at the cutting because the thickness is enough resistant to reduce the fragility of the pastille. The teeth may be disposed according to different angles along the end of the self-sharpening knife.

Several Dispositions of the Pastille
The pastille could be disposed with an angle 30 on the top face 22′ of each tooth 26 and oriented pointing downwards of the knife. This disposition protects the steel part of the teeth by preventing premature wear. The contour of
   the pastille is a cutting point 36, and the pastille always exceeds the part of steel of the tooth.
The pastille could be disposed in sandwich 32 in the middle of each tooth 26′ and fixed in an encavure 44′ made in the steel 22″, the contour is a sharpened point 40 which exceeds the steel part to cut.
The pastille could be positioned straight 34 on the top of each tooth 26″ and disposed parallel to the steel part with its ends being a cutting 52.

The contour of the pastille could be a point of a generally triangular form comprising an end 38, the point is in the center of the pastille and it remains central even during wear because it is supported at its two ends and then becomes less breakable.

Several Forms of a Tooth
Each one of the teeth could have the shape of a pointed triangle 26′″ having two side faces, with the pastille having a rectangular form 58. The pastille constituting one of the two sides faces extending from top 56 to the base of the triangle, at the time of the cutting the elements to be cut are directed directly vis-a-vis the pastilles, thus makes possible to cut more.
Each one of the teeth has a triangular form 27 ending in a point, the tooth comprises a bottom part made of steel 27′ and a triangular pastille 27″ forming the top part of the triangle, the pastille is made of a material harder than steel.

The steel plate is of a generally triangular form, the series of teeth is located along the base of the triangle, the means of fasteners are holes 28 made in the plate and being used to fix the self-sharpening knife to the agricultural machine.

The triangle of the steel plate could be truncated on its height and it comprises a vertical fold on the segment joining the apex of the truncated triangle, the fold being used to attach the knife to the agricultural machine and to have various angles of attack of the series of teeth. The base of the triangle could be straight 24.

The base could be convex. With a convex disposition of the base the teeth are in attack, they are aligned the ones after the others and the cutting puts equal pressure on each one of the teeth, thus conferring to the convex knife a more regular and constant cut, because said teeth wear simultaneously.

The base could be concave 48. The base could form a half-circle 50.

Material of the Pastille

The pastille could be a carbide, or a diamond.

The agricultural machine could be a cutting machine, or a mixer.

The steel constituting the self sharpening knife could be a hardened steel who has a heat treatment, the hardened steel wears less quickly than an ordinary steel not hardened, thus avoiding the exposition to impacts of the cutting edge, the cutting edge will then better cut. It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### PARTS

20 Self-sharpening knife
21,29,43,47,49,51 Steel plate
22 Steel of the knife
22′ Steel part of the tooth having a pastille disposed at an angle
22″ Steel part of the tooth having a pastille disposed in sandwich
22′″ Steel part of the tooth having a horizontal pastille
23 Steel part of the old tooth
23′ Steel part of the old tooth with a worn pastille
24 A straight base
25 Convex base
26 Teeth
26′ Teeth with pastilles disposed in sandwich
26″ Teeth with pastilles disposed straight
26′″ Teeth with a form of a sharp triangle
27′ Bottom part of the teeth 27
27′″ Top part of the teeth 27
28 Holes for fixation
30 New pastille
30′ Worn pastille
30″ Pastille worn until the third
32 Pastille disposed in sandwich
34 Pastille disposed straight on the top of the tooth
44 Encavure
44′ Encavure of the pastille 32
52 Cutting
54 Contour
36 Point
38 End of the point
38′ End of the point of the pastille 30′
38″ End of the point of the pastille 30″
40 Point ending the pastille 32
35 End of the point of the pastille 34
42 Convex self-sharpening knife
43 Steel of the knife 42
46 Concave self-sharpening knife
47 Steel plate of the knife 46
48 Concave base
50 self-sharpening knife with a half-circle form
49 Steel plate of the knife 50
58 Rectangular pastille

The embodiments of the invention in which an exclusive property or privilege is claimed are defined as follows:

1. A self-sharpening knife (20,42,46,50) comprising a steel plate (21,29,43,47,49,51) of a geometrical form, said plate comprises aligned along an end a series of teeth (26,26′, 26″,26′″, 27) intended to cut, each one of said teeth comprises a thin pastille (27″, 30,32,34,58) of a material more cutting and harder than steel, said pastille is fixed at the steel part of said tooth, said pastille exceeds steel and ends in a cutting (52,52′) having a contour (54), said contour forming the cutting edge of said tooth, over the cuttings said cutting edge becomes minimally round by keeping a thin diameter, the maximum diameter of said round corresponds to the thickness of said thin pastille, said minimal round allows said cutting edge remaining cutting; said steel of said tooth wears simultaneously and more quickly because it is less harder than said pastille, so said pastille will always exceed said steel part and will cut until it is worn overall its length and all its width, said knife comprises also means of fastener used to fix it at an agricultural machine.

2. The self-sharpening knife of claim 1 wherein said steel plate has a thickness ranging between 3/16 and ½ po.

3. The self-sharpening knife of claim 2 wherein said thin pastille has a thickness ranging between 1/32 and ⅛ po.

4. The self-sharpening knife of any one of claims 1 to 3 wherein said teeth are disposed according to different angles along said end of said self-sharpening knife.

5. The self-sharpening knife of any one of claims 1 to 4 wherein said pastille is disposed with an angle (30) on the top face (22′) of said each tooth (26) and oriented pointing downwards of said knife to protect said steel part by preventing premature wear, said contour of said pastille is a cutting point (36), said pastille always exceeds said part of steel of said tooth.

6. The self-sharpening knife of any one of claims 1 to 5 wherein said pastille is disposed in sandwich (32) in the middle of each tooth (26′) and fixed in an encavure (44′) made in the steel (22″), said contour is a sharpened point (40) which exceeds steel to cut.

7. The self-sharpening knife of any one of claims 1 to 6 wherein said pastille is positioned straight (34) on the top of each tooth (26″), disposed parallel to said steel part, and ends into said cutting (52).

8. The self-sharpening knife of any one of claims 1 to 7 wherein each one of said teeth has the shape of a pointed triangle (26′″) having two side faces, said pastille is of a rectangular form (58), said pastille constituting one of the two sides faces extending from top (56) to the base of said triangle, at the time of the cutting the elements to be cut are directed directly vis-a-vis said pastilles, thus makes possible to cut more.

9. The self-sharpening knife of any one of claims 1 to 8 wherein each one of said tooth has a triangular form (27) ending in a point, said tooth comprises a bottom part made of steel (27′) and a triangular pastille (27″) forming the top part of said triangle, said pastille is made of a material harder than steel.

10. The self-sharpening knife of any one of claims 1 to 9 wherein said steel plate is of a generally triangular form, said series of teeth is located along the base of said triangle, said means of fasteners are holes (28) made in said plate and being used to fix said self-sharpening knife to said agricultural machine.

11. The self-sharpening knife of claim 10 wherein said triangle of said steel plate is truncated on its height and it comprises a vertical fold on the segment joining the apex of said truncated triangle, said fold being used to attach said knife to said agricultural machine and to have various angles of attack of said series of teeth.

12. The self-sharpening knife of claim 10 or 11 wherein said base is straight (24).

13. The self-sharpening knife of claim 10 or 11 wherein said base is convex (25), with this convex disposition said teeth are in attack, they are aligned the ones after the others and the cutting puts equal pressure on each one of said teeth, thus conferring to said convex knife a more regular and constant cut because said teeth wear simultaneously.

14. The self-sharpening knife of claim 10 or 11 wherein said base is concave (48).

15. The self-sharpening knife of claim 10 or 11 wherein said base forms a half-circle (50).

16. The self-sharpening knife of any one of claims 1 to 15 wherein said thin pastille is a carbide.

17. The self-sharpening knife of any one of claims 1 to 16 wherein said agricultural machine is a mixer.

18. The self-sharpening knife of any one of claims 1 to 17 wherein said steel constituting said self-sharpening knife is a hardened steel who has a heat treatment, said hardened steel wears less quickly than an ordinary steel not hardened, thus avoiding the exposition to impacts of said cutting edge, said cutting edge will then better cut.

19. The self-sharpening knife of any one of claims 1 to 18 wherein said pastille is fixed in an encavure made in the steel which has the same form as said pastille.

20. The self-sharpening knife of claim 19 wherein said fixing is silver brazing.
